(19) United States
(12) Patent Application Publication
(10) Pub. No.: US 2026/0152861 A1
(43) Pub. Date: Jun. 4, 2026

(54) Method for converting hydrocarbon raw materials and device THEREOF

(71) Applicant: ShanghaiTech University, Shanghai (CN)

(72) Inventors: Xiaofei GUAN, Shanghai (CN); Xu ZHANG, Shanghai (CN)

(73) Assignee: ShanghaiTech University, Shanghai (CN)

(21) Appl. No.: 19/122,273

(22) PCT Filed: Dec. 7, 2022
(86) PCT No.: PCT/CN2022/137171

§ 371 Date: Apr. 18, 2025

(30) Foreign Application Priority Data
Oct. 21, 2022 (CN) 202211293519.4

(51) Int. Cl. C25B 3/03; C25B 1/24; C25B 1/55; C25B 11/043; C25B 11/046

(52) U.S. Cl. CPC C25B 3/03; C25B 1/24; C25B 1/55; C25B 11/043; C25B 11/046

(57) ABSTRACT

The present disclosure relates to the field of hydrocarbon raw material conversion, in particular to a method for converting hydrocarbon raw materials and a device thereof. The method comprises the following steps: 1) reacting a gaseous hydrocarbon raw material with a halogen to produce a haloalkane and a hydrogen halide; 2) reacting the haloalkane provided in step 1) with an active metal to produce a first unsaturated hydrocarbon and a first metal halide; and 3) reacting the hydrogen halide provided in step 1) with an active metal to produce a second metal halide and hydrogen. In an electrochemical system of the present disclosure, hydrocarbon raw materials can be converted into high-value products such as hydrogen, ethylene, acetylene, propylene, graphite, etc.

### FIELD OF TECHNOLOGY

The present disclosure relates to the field of hydrocarbon raw material conversion, and in particular, to a method for converting hydrocarbon raw materials and a device thereof.

### BACKGROUND

Natural gas is abundant on earth and holds a globally important position among various energy sources. The main component of natural gas is methane, followed by ethane and propane. At present, natural gas is mainly used as a fuel for heat production. Less than 10% of natural gas is used as a chemical raw material. Due to the huge reserves of natural gas in shale gas, coalbed methane, and deep-sea combustible ice, developing technologies that convert natural gas into high-value chemical products has significant environmental and economic importance.

Due to the stability of C—H bonds and the symmetrical structure of methane molecules, efficient conversion of methane remains a challenge. Industrial methane steam reforming for hydrogen production often requires reaction temperatures exceeding 800° C., which results in high energy consumption, high operating costs, and substantial emissions of carbon dioxide, a major greenhouse gas. A patent application discloses a method for converting hydrocarbon feedstocks (including methane) into unsaturated hydrocarbons. The method specifically includes the following steps: (1) halogenating the hydrocarbon feedstock to form haloalkanes, (2) converting the haloalkanes into unsaturated hydrocarbons and hydrogen halides, (3) separating the unsaturated hydrocarbons from the halogenated compounds, and (4) electrolyzing the hydrogen halides in an aqueous medium or gas-phase medium to generate hydrogen and molecular halogens. Although continuous production can be achieved by repeating the above steps, the process is complex and involves multiple steps and reaction chambers, leading to high costs and making large-scale implementation difficult. In addition, the industrial steam cracking method for preparing unsaturated hydrocarbons such as ethylene, propylene, and butadiene from hydrocarbon feedstocks is typically carried out at temperatures exceeding 850° C. and ultra-high pressures, resulting in extremely high energy demands, furthermore, the steam cracking process globally contributes to more than 300 million tons of carbon dioxide emissions each year. Therefore, the development of hydrocarbon conversion processes that are efficient, simple, low-cost, energy-efficient, low-emission, and easy to scale up is of great importance.

### SUMMARY

The present disclosure provides a method for converting hydrocarbon raw materials and a device thereof which realize implementation under mild conditions and high conversion efficiency.

In the first aspect, the present disclosure provides a method for efficiently converting hydrocarbon raw materials, comprising the following steps:
1) reacting a gaseous hydrocarbon raw material with a halogen to produce a haloalkane and a hydrogen halide;
2) reacting the haloalkane from step 1) with an active metal to produce a first unsaturated hydrocarbon and a first metal halide;
3) reacting the hydrogen halide from step 1) with an active metal to produce a second metal halide and a hydrogen.

In an embodiment of the present disclosure, step 1) is carried out under one or more of the following conditions: electrolysis, light irradiation, and heating.

In an embodiment of the present disclosure, in step 1), the hydrocarbon raw material is one or more of methane, ethane, propane, and natural gas. Preferably, the hydrocarbon raw material is methane and/or ethane. More preferably, the hydrocarbon raw material gas is ethane.

In an embodiment of the present disclosure, in step 1), the halogen includes one or more of a halogen ion, a halogen atom, and a halogen molecule. Preferably, the halogen atom includes one or more of Cl, Br, and I. The halogen ion includes a first halogen ion. The halogen molecule includes a first halogen molecule and/or a second halogen molecule. More preferably, the halogen ion includes one or more of Cl⁻, Br⁻, and I⁻. The halogen molecule includes one or more of Cl₂, Br₂, and I₂.

In an embodiment of the present disclosure, in step 1), the haloalkane includes a first haloalkane and/or a second haloalkane. The hydrogen halide includes a first hydrogen halide and/or a third hydrogen halide.

In an embodiment of the present disclosure, in step 2) or step 3), the active metal includes a metal element and/or a liquid alloy. Liquid alloy refers to a metal element dissolved in another metal with a low melting point. Preferably, the metal with a low melting point is one or more of Ga, In, Sn, Pb, Zn, Bi, and Sb. The metal element includes a first metal element. Preferably, the first metal element is an alkali metal and/or an alkaline earth metal. More preferably, the first metal element is one or more of Li, Na, K, Rb, Cs, Mg, Ca, Sr, and Ba.

In an embodiment of the present disclosure, in step 3), the hydrogen includes a first hydrogen and/or a third hydrogen.

In an embodiment of the present disclosure, when step 1) is carried out in an electrolysis system, the electrolysis system comprises an anode, a cathode, and a metal halide molten salt. The metal halide molten salt provides the third metal halide in its molten state, the third metal halide provides a first metal ion and a first halogen ion, and the first metal ion undergoes a reduction reaction at the cathode to provide the first metal element.

In an embodiment of the present disclosure, when step 1) is performed in an electrolysis system, the first halogen ion undergoes an oxidation reaction at the anode to provide the first halogen molecule, and the hydrocarbon raw material undergoes an oxidation reaction with the first halogen molecule at the anode to provide the first haloalkane and the first hydrogen halide.

And/or, the first halogen ion undergoes an oxidation reaction with the hydrocarbon raw material at the anode to provide the first haloalkane and the first hydrogen halide.

Preferably, at least a portion of the first haloalkane and at least a portion of the first hydrogen halide diffuse to the cathode to undergo a reduction reaction to generate one or more of the first hydrogen, the second halogen ion, the first unsaturated hydrocarbon, and the second metal halide.

In an embodiment of the present disclosure, when step 1) is carried out in an electrolysis system, the metal halide molten salt is a melt of the third metal halide. Preferably, the third metal halide is one or more of metal chlorides, metal bromides, and metal iodides. More preferably, the metal chloride includes one or more of LiCl, NaCl, KCl, RbCl, CsCl, MgCl₂, CaCl₂, SrCl₂, BaCl₂, and ZnCl₂; the metal bromide includes one or more of LiBr, NaBr, KBr, RbBr, CsBr, MgBr₂, CaBr₂, SrBr₂, BaBr₂, and ZnBr₂; and the metal iodide includes one or more of LiI, NaI, KI, RbI, CsI, MgI₂, CaI₂, SrI₂, BaI₂, and ZnI₂.

In an embodiment of the present disclosure, when step 1) is performed in an electrolysis system, the flow rate of the hydrocarbon raw material is in a range of 0.02-0.8 cm³/min per volume (1 cm³) of the metal halide molten salt.

In an embodiment of the present disclosure, when step 1) is performed in an electrolysis system, the reaction temperature is in a range of 200-600° C., and the reaction voltage is in a range of 3-10V.

In an embodiment of the present disclosure, when step 1) is performed in an electrolysis system, a reduction reaction includes: the third metal halide accepts electrons to provide the first metal element and the second halogen ion; the first metal element reacts with the first haloalkane to generate the first unsaturated hydrocarbon and the first metal halide. When the first haloalkane is CCl₄, it reacts with the first metal element to produce graphite and the first metal halide; and/or, when the first haloalkane is CCl₄, it decomposes into graphite and chlorine.

In an embodiment of the present disclosure, when step 1) is carried out in an electrolysis system, the reduction reaction also includes: the third metal halide accepts electrons to provide the first metal element and the second halogen ion; the first metal element reacts with the first hydrogen halide to generate the first hydrogen and the second metal halide.

In an embodiment of the present disclosure, when step 1) is performed in an electrolysis system, the reduction reaction further comprises: the first hydrogen halide accepts electrons to generate a second hydrogen and a third halogen ion.

In an embodiment of the present disclosure, when step 1) is carried out in an electrolysis system, the method also includes a step for post treatment of a remaining part of the first haloalkane and a remaining part of the first hydrogen halide, including: reacting the remaining part of the first haloalkane with a basic substance to produce alcohols, aldehydes, carboxylic acids, and a fourth metal halide. Preferably, the basic substance includes one or more of a basic aqueous solution, a basic solid, and a basic melt. More preferably, the basic aqueous solution is a conventional basic solution, such as lithium hydroxide aqueous solution, sodium hydroxide aqueous solution, potassium hydroxide aqueous solution, etc; the basic solid is a conventional solid, such as lithium hydroxide, sodium hydroxide, potassium hydroxide, etc. ; and the basic melt is selected from molten lithium hydroxide, molten sodium hydroxide, molten potassium hydroxide, etc.

In an embodiment of the present disclosure, when step 1) is performed in an electrolysis system, the step for post treatment further includes reacting the remaining part of the first haloalkane in the presence of a catalyst to produce a second unsaturated hydrocarbon and the second hydrogen halide. The catalyst is a zeolite catalyst.

In an embodiment of the present disclosure, when step 1) is performed in an electrolysis system, the step for post treatment further includes reacting the remaining part of the first haloalkane with an active metal to produce a third unsaturated hydrocarbon and a fifth metal halide.

In an embodiment of the present disclosure, when step 1) is carried out in an electrolysis system, the step for post treatment further includes recovering the remaining portion of the first haloalkane and reintroducing it for reaction to produce the first unsaturated hydrocarbon and the first metal halide.

In an embodiment of the present disclosure, when step 1) is performed in an electrolysis system, the step for post treatment further includes reacting the remaining part of the first hydrogen halide with an active metal to produce a sixth metal halide and the third hydrogen.

In an embodiment of the present disclosure, when step 1) is performed under light irradiation and/or heating, a wavelength of light ranges from 200 to 450 nm, a reaction temperature ranges from 20 to 600° C., and a heating temperature is no less than 250° C. Under the light irradiation and/or heating conditions, the gaseous hydrocarbon raw material reacts with the gaseous second halogen molecule to provide the second haloalkane and the third hydrogen halide, the second haloalkane reacts with an active metal to provide the third unsaturated hydrocarbon and the fifth metal halide, and the third hydrogen halide reacts with an active metal to provide the sixth metal halide and the third hydrogen.

In an embodiment of the present disclosure, when step 1) is carried out under light irradiation and/or heating, the method also includes a step for post treatment, including electrolyzing the fifth metal halide and/or the sixth metal halide to provide a second metal element and a second halogen gas, recycling the second metal element for use in step 2) or step 3), and recycling the second halogen gas for use in step 1).

In the second aspect, the present disclosure provides an electrochemical device, including a reaction container, wherein the reaction container includes a metal halide molten salt unit and a vent pipe. The metal halide molten salt unit is provided with an anode and a cathode, and the vent pipe enables gas to reach the anode and is communicated with the metal halide molten salt unit.

In an embodiment of the present disclosure, the vent pipe is provided with a gas inlet port.

In an embodiment of the present disclosure, the electrochemical device further includes an independent chamber, wherein the independent chamber is communicated with the reaction container and is not in contact with the metal halide molten salt unit.

In an embodiment of the present disclosure, the vent pipe is sleeved on the anode, and the cathode is sleeved on the vent pipe.

In an embodiment of the present disclosure, at least part of the cathode is disposed in the metal halide molten salt.

In an embodiment of the present disclosure, the anode is closer to a bottom of the reaction container than the vent pipe.

In an embodiment of the present disclosure, the anode is made of graphite.

In an embodiment of the present disclosure, the cathode is made of stainless steel, nickel, titanium, and nickel-based alloy.

In an embodiment of the present disclosure, the reaction container is made of alumina.

In an embodiment of the present disclosure, the vent pipe is ceramic and insulated.

In the third aspect, the present disclosure provides a use of the method and/or the electrochemical device for converting hydrocarbon raw material in preparing unsaturated hydrocarbons.

The present disclosure has the following beneficial effects:

First, electrolysis conditions:
1. The electrochemical method in the present disclosure produces halogen atoms or halogen molecules in situ at the anode to activate stable hydrocarbon raw material and efficiently convert the hydrocarbon raw material into haloalkanes and hydrogen halides.
2. The electrochemical method in the present disclosure produces active metals in situ at the cathode for reaction with haloalkanes, and reduces hydrogen halides in situ at the cathode, thereby converting the hydrocarbon raw material into high-value products, such as hydrogen, ethylene, acetylene, propylene, graphite, etc.
3. The above reactions can be carried out in the electrochemical system, avoiding multiple steps and reactors, thus greatly simplifying the overall process.

Second, light irradiation or heating condition:
1. Active metals can react with haloalkanes and hydrogen halides to produce high-value products such as hydrogen, ethylene, acetylene, propylene, graphite, etc.
2. The resulting metal halides are easily separable, due to that the metal halides form a different phase from the active metals, are immiscible with the active metals, as well as that the metal halides and the active metals have a density difference.
3. The separated metal halides can regenerate active metals and halogen gases through electrolysis, enabling recycling and a closed-loop process that is not only simple and efficient but also facilitates source recovery and reuse.

Third, the overall method:
1. The reaction conditions are relatively milder. High pressure is not required, for example, the reactions can be carried out at a pressure of 1 to 5 atm, which is significantly lower than the conventional 20 to 100 atm. The reaction temperature is also relatively low, typically about 200-600° C., which is significantly lower than the conventional 850° C.
2. The reaction process is simpler. There is no need to pre-remove the sulfur-containing gases and carbon dioxide in the hydrocarbon raw material, the feed gas can be directly introduced into the system for conversion.
3. The method avoids the formation of by-products, such as carbon dioxide, and also prevents catalyst deactivation caused by surface carbon deposition or other inert substances (including solid oxides and solid salts), which commonly poison traditional catalysts.
4. The method offers high cost-effectiveness. No precious metals are used, instead, the materials used are inexpensive and abundantly available, leading to low overall costs.

### BRIEF DESCRIPTION OF THE DRAWINGS

FIG. 1 is a schematic diagram showing a first partial structure of an electrochemical device of the present disclosure.

FIG. 2 is a schematic diagram showing a second partial structure of the electrochemical device of the present disclosure.

FIG. 3 is a schematic diagram showing a first overall structure of the electrochemical device of the present disclosure.

FIG. 4 is a schematic diagram showing a second overall structure of the electrochemical device of the present disclosure.

FIG. 5 shows an NMR spectrum of an output gas of Embodiment 1 of the present disclosure.

FIG. 6 is a gas chromatogram showing hydrogen in the output gas of Embodiment 1 of the present disclosure.

FIG. 7 is a gas chromatogram showing ethylene in the output gas of Embodiment 1 of the present disclosure.

FIG. 8 is a gas chromatogram showing acetylene in the output gas of Embodiment 1 of the present disclosure.

FIG. 9 shows an NMR spectrum of an output gas of Embodiment 2 of the present disclosure.

FIG. 10 shows an NMR spectrum of an output gas of Embodiment 3 of the present disclosure.

FIG. 11 shows an NMR spectrum of an output gas of Embodiment 4 of the present disclosure.

FIG. 12 shows an NMR spectrum of an output gas of Embodiment 5 of the present disclosure.

FIG. 13 shows an NMR spectrum of an output gas of Embodiment 6 of the present disclosure.

FIG. 14 shows an NMR spectrum of an output gas of Embodiment 7 of the present disclosure.

FIG. 15 shows an NMR spectrum of an output gas of Embodiment 8 of the present disclosure.

FIG. 16 is a gas chromatogram showing hydrogen in an output gas of Embodiment 9 of the present disclosure.

FIG. 17 is a gas chromatogram showing ethylene in the output gas of Embodiment 9 of the present disclosure.

FIG. 18 is a gas chromatogram showing acetylene in the output gas of Embodiment 9 of the present disclosure.

FIG. 19 is a gas chromatogram showing chloroform in Embodiment 10 of the present disclosure.

FIG. 20 is a gas chromatogram showing ethylene in an output gas produced at a reaction temperature of 400° C. according to Embodiment 10 of the present disclosure.

FIG. 21 is a gas chromatogram showing acetylene in the output gas produced at a reaction temperature of 400° C. according to Embodiment 10 of the present disclosure.

FIG. 22 is a gas chromatogram showing ethylene in an output gas produced at a reaction temperature of 500° C. according to Embodiment 10 of the present disclosure.

FIG. 23 is a gas chromatogram showing acetylene in the output gas produced at a reaction temperature of 500° C. according to Embodiment 10 of the present disclosure.

FIG. 24 is a gas chromatogram showing dichloromethane in Embodiment 11 of the present disclosure.

FIG. 25 is a gas chromatogram showing ethylene in an output gas produced at a reaction temperature of 400° C. according to Embodiment 11 of the present disclosure.

FIG. 26 is a gas chromatogram showing acetylene in the output gas produced at a reaction temperature of 400° C. according to Embodiment 11 of the present disclosure.

FIG. 27 is a gas chromatogram showing ethylene in an output gas produced at a reaction temperature of 500° C. according to Embodiment 11 of the present disclosure.

FIG. 28 is a gas chromatogram showing ethylene in an output gas produced at a reaction temperature of 500° C. according to Embodiment 12 of the present disclosure.

FIG. 29 is a gas chromatogram showing acetylene in the output gas produced at a reaction temperature of 500° C. according to Embodiment 12 of the present disclosure.

FIG. 30 shows an XRD characterization result of a silver bulk metal on a solidified molten salt of Embodiment 1 of the present disclosure.

FIG. 31 shows an XRD characterization result of a black substance on the solidified molten salt of Embodiment 1 of the present disclosure.

### REFERENCE NUMERALS

1 Reaction container
2 Cathode
3 Anode
4 Metal halide molten salt unit
5 Vent pipe
6 Gas inlet port
7 Independent chamber

### DETAILED DESCRIPTION

In order to make the purpose, technical solutions, and beneficial effects of the present disclosure clear, the present disclosure is further described below in conjunction with the examples. It should be understood that the examples are only used to illustrate the present disclosure and are not intended to limit the scope of the present disclosure. The experimental methods used in the following examples are conventional unless otherwise specified. Those skilled in the art can easily understand other advantages and effects of the present disclosure from the contents disclosed in this description.

The term “range” in the present disclosure is defined by a lower limit and an upper limit, and a given range is defined by selecting a lower limit and an upper limit, which together set the boundaries of the particular range. Such range may include or exclude the endpoints, and any combination of the listed lower and upper limits is contemplated. For example, if the ranges of 60 to 120 and 80 to 110 are disclosed for a specific parameter, it is to be understood that the ranges of 60 to 110 and 80 to 120 are also contemplated. In addition, if the minimum values 1 and 2 are listed, and the maximum values 3, 4, and 5 are listed, it is to be understood that all combinations thereof are contemplated, including: 1 to 3, 1 to 4, 1 to 5, 2 to 3, 2 to 4, and 2 to 5. In the present disclosure, unless otherwise specified, the numerical range “a to b” represents any real number combination between a and b, where a and b are both real numbers. For example, the numerical range “0 to 5” encompasses all real numbers between 0 and 5, and “0 to 5” is just a concise representation of all the numerical combinations. In addition, when a parameter is expressed as being an integer ≥2, for example, an integer of 2, 3, 4, 5, 6, 7, 8, 9, 10, 11, 12, etc, is disclosed.

Unless otherwise specified, all steps of the present disclosure may be performed sequentially or randomly, with sequential execution being preferred. For example, if the method includes steps 1) and 2), it indicates that the method may include step 1) followed by step 2), or may include step 2) followed by step 1).

After extensive exploration and research, the inventors of the present disclosure developed a method and an electrochemical device for efficiently converting hydrocarbon raw materials, which can effectively activate gaseous hydrocarbon raw materials to produce high-value products, including hydrogen, ethylene, acetylene, propylene, etc. under relatively low temperature.

In the first aspect, the present disclosure provides a method for converting hydrocarbon raw materials, comprising the following steps:
1) reacting a gaseous hydrocarbon raw material with a halogen to produce a haloalkane and a hydrogen halide;
2) reacting the haloalkane in step 1) with an active metal to produce a first unsaturated hydrocarbon and a first metal halide;
3) reacting the hydrogen halide in step 1) with an active metal to produce a second metal halide and hydrogen.

In the method for converting hydrocarbon raw materials provided in the present disclosure, step 1) is carried out under one or more of the following conditions: electrolysis, light irradiation, and heating.

In the method for converting hydrocarbon raw materials provided in the present disclosure, in step 1), the hydrocarbon raw material is one or more of methane, ethane, propane, and natural gas. Preferably, the hydrocarbon raw material is methane and/or ethane. More preferably, the hydrocarbon raw material is ethane.

In the method for converting hydrocarbon raw materials provided in the present disclosure, in step 1), the halogen includes one or more of a halogen ion, a halogen atom, and a halogen molecule. Preferably, the halogen atom includes one or more of Cl, Br, and I, the halogen ion includes a first halogen ion, and the halogen molecule includes a first halogen molecule and/or a second halogen molecule. More preferably, the first halogen ion is one or more of Cl⁻, Br⁻, and I⁻, and the first halogen molecule or the second halogen molecule is one or more of Cl₂, Br₂, and I₂. The halogen atom participates in the reaction as an intermediate species in the form of a free radical, which is relatively active. The haloalkane includes a first haloalkane and/or a second haloalkane, and the hydrogen halide includes a first hydrogen halide and/or a third hydrogen halide. The first haloalkane or the second haloalkane may be, for example, a monohaloalkane, a dihaloalkane, or a polyhaloalkane. The monohaloalkane may be, for example, a monochloroalkane, a monobromoalkane, or a monoiodoalkane. Other examples are not described repeatedly. The first hydrogen halide or the third hydrogen halide is selected from hydrogen chloride, hydrogen bromide, hydrogen iodide, and the like.

In the method for converting hydrocarbon raw materials provided in the present disclosure, in step 2) or step 3), the first metal halide can be obtained from the reaction of a specifically selected haloalkane and a specifically selected active metal. For example, a monochloroalkane reacts with Na to obtain NaCl. The same to the second metal halide.

In the method for converting hydrocarbon raw materials provided in the present disclosure, in step 2) or step 3), the active metal includes a metal element and/or a liquid alloy. The metal element includes a first metal element. Preferably, the first metal element is selected from alkali metals and alkaline earth metals. More preferably, the first metal element is one or more of Li, Na, K, Rb, Cs, Mg, Ca, Sr, and Ba. Liquid alloy refers to a metal element dissolved in another metal with a low melting point. Preferably, the metal with a low melting point is one or more of Ga, In, Sn, Pb, Zn, Bi, and Sb. The metal element in the liquid alloy participates in the reaction, and the role of the metal with a low melting point in the liquid alloy facilitates the alloy formation and reduces the corrosiveness to the surrounding environment.

In the method for converting hydrocarbon raw materials provided in the present disclosure, in step 3), the hydrogen includes a first hydrogen and/or a third hydrogen.

In the method for converting hydrocarbon raw materials provided in the present disclosure, when step 1) is carried out in an electrolysis system, the electrolysis system comprises an anode, a cathode, and a metal halide molten salt. The anode is made of graphite. The cathode is made of one or more of stainless steel, nickel, titanium, and nickel-based alloy.

In the method for converting hydrocarbon raw materials provided in the present disclosure, when step 1) is carried out in an electrolysis system, the metal halide molten salt is a melt of the third metal halide. The melt of the third metal halide means that the third metal halide turns into a molten state when the temperature reaches its melting point. The melting point is in a range of 200˜600° C.; preferably 200˜300° C., 300˜400° C., 400˜500° C., 500˜600° C., etc. The metal halide molten salt provides the third metal halide in its molten state, wherein the third metal halide exists in an ionic state, and the third metal halide is used to provide a first metal ion and a first halogen ion, serving as the electrolyte for the electrolysis. The first metal ion is selected from alkali metal ions and alkaline earth metal ions, Preferably, the first metal ion is one or more of Li⁺, Na⁺, K⁺, Rb⁺, Cs⁺, Mg²⁺, Ca²⁺, Sr²⁺, and Ba²⁺.

In the method for converting hydrocarbon raw materials provided in the present disclosure, when step 1) is carried out in an electrolysis system, one or more of the following reactions is carried out at the anode:
A1) The first halogen ion undergoes an oxidation reaction at the anode to provide the first halogen molecule, and the gaseous hydrocarbon raw material and the first halogen molecule undergo an oxidation reaction at the anode to provide the first haloalkane and the first hydrogen halide.

In a specific embodiment, when the first halogen ion is chloride ion and the hydrocarbon raw material is methane, for example, the produced first haloalkane may be methyl chloride and the first hydrogen halide may be hydrogen chloride. The specific reaction formula is 2Cl⁻=Cl₂(g)+2e⁻, Cl₂(g)+CH₄(g)=CH₃Cl(g)+HCl(g).
A2) The first halogen ion undergoes an oxidation reaction with the gaseous hydrocarbon raw material at the anode to provide the first haloalkane and the first hydrogen halide.

In a specific embodiment, when the first halogen ion is chloride ion and the hydrocarbon raw material gas is methane, for example, the produced first haloalkane may be methyl chloride and the first hydrogen halide may be hydrogen chloride. The specific reaction formula is CH₄(g)+2Cl⁻=CH₃Cl(g)+HCl(g)+2e⁻.

The first hydrogen halide and the first haloalkane produced at the anode are mostly in the form of gas. At least a portion of the first haloalkane and at least a portion of the first hydrogen halide diffuse to the cathode for a reduction reaction. During the gas diffusion process, the gaseous hydrocarbon raw material that has not been converted at the anode may continue to react with the first halogen ion or the first halogen molecule to generate more first haloalkane and first hydrogen halide.

In the method for converting hydrocarbon raw materials provided by the present disclosure, when step 1) is carried out in an electrolysis system, the third metal halide is one or more of a metal chloride, a metal bromide, and a metal iodide. Preferably, the metal chloride includes one or more of LiCl, NaCl, KCl, RbCl, CsCl, MgCl₂, CaCl₂, SrCl₂, BaCl₂, and ZnCl₂. The metal bromide includes one or more of LiBr, NaBr, KBr, RbBr, CsBr, MgBr₂, CaBr₂, SrBr₂, BaBr₂, and ZnBr₂. The metal iodide includes one or more of LiI, NaI, KI, RbI, CsI, MgI₂, CaI₂, SrI₂, BaI₂, and ZnI₂.

In the method for converting hydrocarbon raw materials provided in the present disclosure, when step 1) is carried out in an electrolysis system, for per unit volume (1 cm³) of metal halide molten salt, the flow rate of the hydrocarbon raw material ranges from 0.02 to 0.8 cm³/min. Preferably, for per unit volume (1 cm³) of molten salt, the gas flow rate at the gas inlet port is 0.072 cm³/min. In a specific embodiment of the present disclosure, for per unit volume (1 cm³) of molten salt, if the gas flow rate at the gas inlet port ranges from 0.02 to 0.8 cm³/min, then for 70 cm³ of molten salt, the gas flow rate ranges from (0.02×70=1.4) to (0.8×70=56) cm³/min. In a preferred embodiment of the present disclosure, for per unit volume (1 cm³) of molten salt, if the gas flow rate at the gas inlet port is 0.072 cm³/min, then for 70 cm³ of molten salt, the gas flow rate is 0.072×70=5.04 cm³/min. The gas flow rate is limited to make the amount of the gaseous hydrocarbon raw material gas close to the amount of the gaseous first halogen molecule generated at the anode. If the amount of the gaseous hydrocarbon raw material is much smaller than the amount of the gaseous first halogen molecule generated at the anode, then the first halogen molecule that does not react with the hydrocarbon raw material will diffuse to the cathode, consuming the first metal element and the first hydrogen generated at the cathode, thereby reducing the amount of high-value products. If the flow rate of the hydrocarbon raw material is too high, the retention time of the hydrocarbon raw material in the reactor is largely reduced, thereby decreasing the conversion rate of the hydrocarbon raw material.

In the method for converting hydrocarbon raw materials provided in the present disclosure, when step 1) is carried out in an electrolysis system, the reaction temperature of the electrolysis system is 200-600° C., preferably 200-300° C., 300-400° C., 400-500° C., or 500-600° C. The reaction voltage of the electrolysis system is 3-10V, preferably 3-4V, 4-5V, 5-8V, or 8-10V.

In the method for converting hydrocarbon raw materials provided in the present disclosure, when step 1) is carried out in an electrolysis system, the reduction reaction includes one or more of the following:
B1) The third metal halide accepts electrons to provide the first metal element and the second halogen ion, and the first metal element reacts with the first haloalkane to produce the first unsaturated hydrocarbon and the first metal halide. The first unsaturated hydrocarbon may be, for example, an alkene or an alkyne. An alkene may be, for example, ethylene, propylene, etc. An alkyne may be, for example, acetylene, propyne, etc. When the first haloalkane is CCl₄, CCl₄ reacts with the first metal element to produce graphite and the first metal halide, or CCl₄ itself decomposes into graphite and chlorine. The graphite may be located at the bottom of the third metal halide, float on the third metal halide, or be dispersed throughout the third metal halide (it should be noted that the metal halide molten salt provides the third metal halide in its molten state), depending on the density of the graphite and the third metal halide, the viscosity of the third metal halide, and the ventilation conditions.

In a specific embodiment, when the third metal halide is NaCl, the reaction formula is NaCl +e⁻=Na+Cl⁻. When the first metal element is Na and the first haloalkane is CH₂Cl₂, the reaction formula is 2CH₂Cl₂+4Na=C₂H₄+4NaCl. When the first metal element is Na and the first haloalkane is CHCl₃, the reaction formula is 2CHCl₃+6Na=C₂H₂+6NaCl. When the first metal element is Na and the first haloalkane is CH₂Cl—CH₂Cl, the reaction formula is CH₂Cl—CH₂Cl+2Na=C₂H₄+2NaCl. When the first metal element is Na and the first haloalkane is CCl₄, the reaction formula is CCl₄+4Na=C(graphite)+4NaCl.
B2) The third metal halide accepts electrons to provide the first metal element and the second halogen ion, and the first metal element reacts with the first hydrogen halide to produce the first hydrogen and the second metal halide. The second halogen ion is one or more of Cl⁻, Br⁻, and I⁻.

In a specific embodiment, when the third metal halide is LiCl, the reaction formula is LiCl +e⁻=Li+Cl⁻, Li+HCl=½H₂+LiCl.
B3) The first hydrogen halide accepts electrons to produce the second hydrogen and the third halogen ion. The third halogen ion is one or more of Cl⁻, Br⁻, and I⁻.

In a specific embodiment, when the first hydrogen halide is HCl, the reaction formula is HCl+e⁻=½H₂+Cl⁻.

In the method for converting hydrocarbon raw materials provided in the present disclosure, when step 1) is carried out in an electrolysis system, the method also includes a step for post treatment of the remaining part of the first haloalkane and the remaining part of the first hydrogen halide, including one or more of the following:
C1) Reacting the remaining part of the first haloalkane with a basic substance to produce alcohols, aldehydes, carboxylic acids, and a fourth metal halide, which not only effectively utilizes the first haloalkane but also recycles halogen elements. Preferably, the basic substance includes one or more of a basic aqueous solution, a basic solid, and a basic melt. More preferably, the basic aqueous solution is a conventional basic solution such as lithium hydroxide aqueous solution, sodium hydroxide aqueous solution, potassium hydroxide aqueous solution, etc, the basic solid is a conventional solid such as lithium hydroxide, sodium hydroxide, potassium hydroxide, etc, and the basic melt is selected from molten lithium hydroxide, molten sodium hydroxide, molten potassium hydroxide, etc. The fourth metal halide is one or more of metal chlorides, metal bromides, and metal iodides. Preferably, the metal chloride includes one or more of LiCl, NaCl, KCl, RbCl, CsCl, MgCl₂, CaCl₂, SrCl₂, BaCl₂, and ZnCl₂, the metal bromide includes one or more of LiBr, NaBr, KBr, RbBr, CsBr, MgBr₂, CaBr₂, SrBr₂, BaBr₂, and ZnBr₂, and the metal iodide includes one or more of LiI, NaI, KI, RbI, CsI, MgI₂, CaI₂, SrI₂, BaI₂, and ZnI₂.
C2) Reacting the remaining part of the first haloalkane under the action of a catalyst to produce a second unsaturated hydrocarbon and the second hydrogen halide. The catalyst is a zeolite catalyst. The second unsaturated hydrocarbon may be, for example, an alkene or an alkyne. The alkene may be, for example, ethylene, propylene, etc. The alkyne may be, for example, acetylene, propyne, etc. The second hydrogen halide is selected from hydrogen chloride, hydrogen bromide, hydrogen iodide, etc.
C3) Reacting the remaining part of the first haloalkane with an active metal to produce a third unsaturated hydrocarbon and a fifth metal halide. The third unsaturated hydrocarbon may be, for example, an alkene or an alkyne. The alkene may be, for example, ethylene, propylene, etc. The alkyne may be, for example, acetylene, propyne, etc. The fifth metal halide is one or more of metal chlorides, metal bromides, and metal iodides. Preferably, the metal chloride is one or more of LiCl, NaCl, KCl, RbCl, CsCl, MgCl₂, CaCl₂, SrCl₂, BaCl₂, and ZnCl₂, the metal bromide is one or more of LiBr, NaBr, KBr, RbBr, CsBr, MgBr₂, CaBr₂, SrBr₂, BaBr₂, and ZnBr₂, and the metal iodide is one or more of LiI, NaI, KI, RbI, CsI, MgI₂, CaI₂, SrI₂, BaI₂, and ZnI₂. The corresponding examples are shown in Embodiments 10 to 12 of the present disclosure.
C4) Recovering the remaining part of the first haloalkane and re-introducing it for reaction to produce the first unsaturated hydrocarbon and the first metal halide.
C5) Reacting the remaining part of the first hydrogen halide with an active metal to produce a sixth metal halide and the third hydrogen.

In the method for converting hydrocarbon raw materials provided in the present disclosure, when step 1) is carried out under light irradiation and/or heating, a wavelength of light ranges from 200 to 450 nm; preferably 200 to 250 nm, 250 to 350 nm, 350 to 450 nm, etc, a reaction temperature ranges from 20 to 600° C., preferably, 20 to 100° C., 100 to 200° C., 200 to 600° C., etc, and a heating temperature is no less than 250° C. Under light irradiation and/or heating conditions, the gaseous hydrocarbon raw material reacts with the gaseous second halogen molecule to provide the second haloalkane and the third hydrogen halide, the second haloalkane reacts with an active metal to provide a third unsaturated hydrocarbon and the fifth metal halide, and the third hydrogen halide reacts with an active metal to provide the sixth metal halide and the third hydrogen. The sixth metal halide is one or more of metal chlorides, metal bromides, and metal iodides. Preferably, the metal chloride is one or more of LiCl, NaCl, KCl, RbCl, CsCl, MgCl₂, CaCl₂, SrCl₂, BaCl₂, and ZnCl₂, the metal bromide is selected from a combination of one or more of LiBr, NaBr, KBr, RbBr, CsBr, MgBr₂, CaBr₂, SrBr₂, BaBr₂, and ZnBr₂, and the metal iodide is one or more of LiI, NaI, KI, RbI, CsI, MgI₂, CaI₂, SrI₂, BaI₂, and ZnI₂.

In an embodiment of the present disclosure, when step 1) is performed under light irradiation and/or heating, the method further includes a step for post treatment: electrolyzing the fifth metal halide and/or the sixth metal halide to provide a second metal element and a second halogen molecule, recycling the second metal element for use in step 2) or step 3), and recycling the second halogen molecule for use in step 1). The second metal element is one or more of Li, Na, K, Rb, Cs, Mg, Ca, Sr, and Ba.

In a second aspect, the present disclosure provides an electrochemical device, including a reaction container 1, wherein the reaction container 1 includes a metal halide molten salt unit 4. The metal halide molten salt unit 4 is provided with an anode 3 and a cathode 2. The electrochemical device also includes a vent pipe 5 for supplying gas to the anode 3. The vent pipe 5 is communicated with the metal halide molten salt unit 4. The vent pipe 5 is provided with a gas inlet port 6. The gas that passes through the gas inlet port 6 is the hydrocarbon raw material, and the hydrocarbon raw material is one or more of methane, ethane, propane, and natural gas. Preferably, the hydrocarbon raw material is methane and/or ethane. More preferably, the hydrocarbon raw material is ethane.

In the electrochemical device provided in the present disclosure, metal halide molten salt is provided in the metal halide molten salt unit 4. The metal halide molten salt is a melt of the third metal halide. The third metal halide is one or more of LiCl, NaCl, KCl, RbCl, CsCl, MgCl₂, CaCl₂, SrCl₂, BaCl₂, ZnCl₂, LiBr, NaBr, KBr, RbBr, CsBr, MgBr₂, CaBr₂, SrBr₂, BaBr₂, ZnBr₂, LiI, NaI, KI, RbI, CsI, MgI₂, CaI₂, SrI₂, BaI₂, and ZnI₂.

In the electrochemical device provided in the present disclosure, the anode 3 is made of graphite, and the cathode 2 is made of stainless steel, nickel, titanium, or nickel-based alloy. The reaction container 1 is made of alumina, and the height of the reaction container 1 ranged from 30 to 60 cm. The venti pipe 5 is a ceramic insulating pipe.

In the electrochemical device provided in the present disclosure, the anode 3 is closer to the bottom of the reaction container 1 than the vent pipe 5, so as to ensure that the anode 3 protrudes from the vent pipe 5 to be in contact with the molten salt in the metal halide molten salt unit 4. The anode 3 immersed in the molten salt in the metal halide molten salt unit 4 to a length ranging from 10 to 15 cm. The vent pipe 5 immersed in the molten salt in the metal halide molten salt unit 4 to a length ranging from 7 to 12 cm. The cathode 2 immersed in the molten salt in the metal halide molten salt unit 4 ranging from 4 to 9 cm.

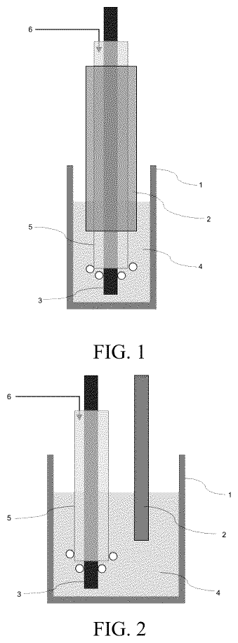

In the electrochemical device provided in the present disclosure, the vent pipe 5 is sleeved on the anode 3. As shown in FIG. 1, the cathode 2 can be sleeved on the vent pipe 5, in which case the vent pipe 5 is closer to the bottom of the reaction container 1 than the cathode 2, and the vent pipe 5 can be in communicated with the molten salt in the metal halide molten salt unit 4. In the metal halide molten salt unit 4, the length immersed in the molten salt from long to short is anode 3 >vent pipe 5>cathode 2. As shown in FIG. 2, the cathode 2 and the vent pipe 5 may be separately arranged in the metal halide molten salt unit 4, in this case, the anode 3 may be closer to the bottom of the reaction container 1 than the cathode 2, the anode 3 may be flush with the cathode 2, or the anode 3 may be farther away from the bottom of the reaction container 1 than the cathode 2.

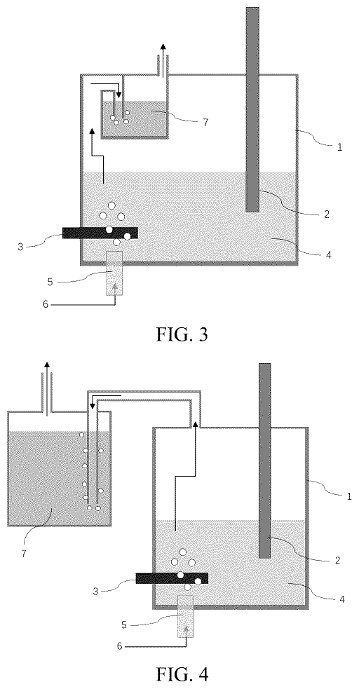

The electrochemical device provided in the present disclosure also includes an independent chamber 7. The independent chamber 7 is communicated with the reaction container 1 and is not in contact with the metal halide molten salt unit 4. An active metal is provided in the independent chamber 7. The active metal includes a metal element and/or a liquid alloy. The metal element includes one or more of Li, Na, K, Rb, Cs, Mg, Ca, Sr, and Ba. The liquid alloy refers to one metal element dissolved in another metal with a low melting point, and the metal with a low melting point includes one or more of Ga, In, Sn, Pb, Zn, Bi, and Sb. The metal with a low melting point does not participate in the reaction and functions in forming a liquid alloy, wherein the formed liquid alloy is less corrosive to the independent chamber 7. As shown in FIG. 3, the independent chamber 7 is arranged inside the reaction container 1, for example, it may be arranged at the top. As shown in FIG. 4, the independent chamber 7 is arranged outside the reaction container.

The electrochemical device provided in the present disclosure operates under the applied voltage and temperature. The voltage is in a range of 3 to 10 V; preferably 3 to 4 V, 4 to 5 V, 5 to 8 V, or 8 to 10 V. The temperature is in a range of 200 to 600° C.; preferably 200 to 300° C., 300 to 400°C., 400 to 500° C., or 500 to 600° C.

In the electrochemical device provided in the present disclosure, hydrocarbon raw material is introduced into the gas inlet port 6, an oxidation reaction occurs at the anode 3, and the hydrocarbon raw material reacts with the halogen ion provided by the molten salt in the metal halide molten salt unit 4 to produce the first haloalkane and the first hydrogen halide.

In the electrochemical device provided in the present disclosure, at least a portion of the first haloalkane and at least a portion of the first hydrogen halide diffuse to the cathode 2, and undergo a reduction reaction to provide one or more of the first hydrogen, the second halogen ion, the first unsaturated hydrocarbon, and the second metal halide.

In FIGS. 3 and 4, the remaining part of the first haloalkane and the remaining part of the first hydrogen halide generated at the anode 3 reach the independent chamber 7 and react with the active metal to produce the third unsaturated hydrocarbon, the fifth metal halide, the sixth metal halide, and the third hydrogen. Specifically, when the remaining part of the first haloalkane reacts with the active metal, the third unsaturated hydrocarbon and the fifth metal halide are produced. Specifically, when the remaining part of the first hydrogen halide reacts with the active metal, the sixth metal halide and the third hydrogen are produced.

In FIGS. 3 and 4, the gaseous hydrocarbon raw material may also react with the gaseous second halogen molecule in the independent chamber to produce the second haloalkane and the third hydrogen halide. The second haloalkane may react with the active metal to produce the third unsaturated hydrocarbon and the fifth metal halide. The third hydrogen halide may react with the active metal to produce the sixth metal halide and the third hydrogen.

In FIGS. 3 and 4, the third unsaturated hydrocarbon can be produced from the above two manners, thereby further increasing the total amount of the produced unsaturated hydrocarbons. At the same time, the produced fifth metal halide and sixth metal halide may rise to the surface of the liquid alloy, remain immiscible with the liquid alloy, and are easily separated. The separated metal halide can then be reused in the metal halide molten salt unit 4 for the electrochemical reaction.

In the third aspect, the present disclosure provides a use of the method for converting hydrocarbon raw materials and/or the electrochemical device in preparing unsaturated hydrocarbons. Unsaturated hydrocarbons can be used as chemical raw materials and have high industrial value.

The present disclosure is further described below by way of examples, but the scope of the present disclosure is not limited thereby.

The following are the formulas for calculating the methane conversion rate and ethane conversion rate of the embodiments: methane conversion rate (%)=(amount of methane flowing into the reactor−amount of methane flowing out the reactor)/(amount of methane flowing into the reactor)*100%; ethane conversion rate (%)=(amount of ethane flowing into the reactor−amount of ethane flowing out the reactor)/(amount of ethane flowing into the reactor)*100%.

### Embodiment 1

Converting Methane to High-Value Products Using an Electrochemical Device with LiCl—NaCl—KCl Molten Salt Electrolyte

A total of 65.27 g of 44% LiCl-25% NaCl-31% KCl (molar fraction) was loaded into an alumina reaction container with an inner diameter of 22 mm and a sealed end. The alumina reaction container was placed in a high-temperature tube furnace. At a temperature of 500° C., the salt LiCl—NaCl—KCl melted to form a molten salt with a height of about 10 cm. As shown in FIG. 1, a graphite anode (diameter: 3mm) was inserted to the bottom of the molten salt electrolyte. A ceramic insulating vent pipe made of alumina was sleeved on the graphite anode. The graphite anode protruded about 3 cm beyond the ceramic insulating vent pipe. The cathode was a stainless steel tube, which was inserted about 4 cm into the salt electrolyte. The stainless steel tube cathode is sleeved on the outside of the ceramic insulating vent pipe.

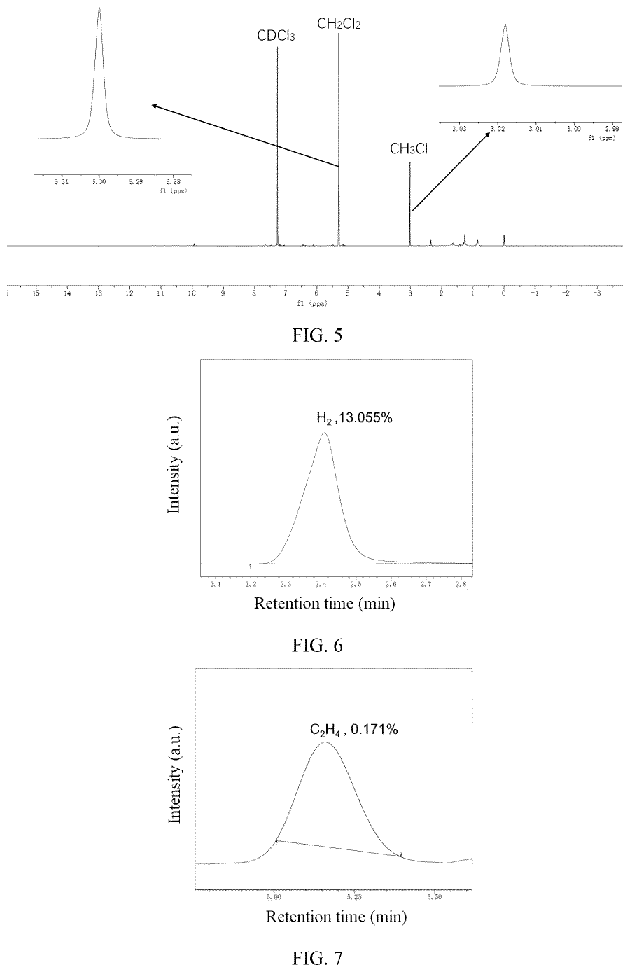

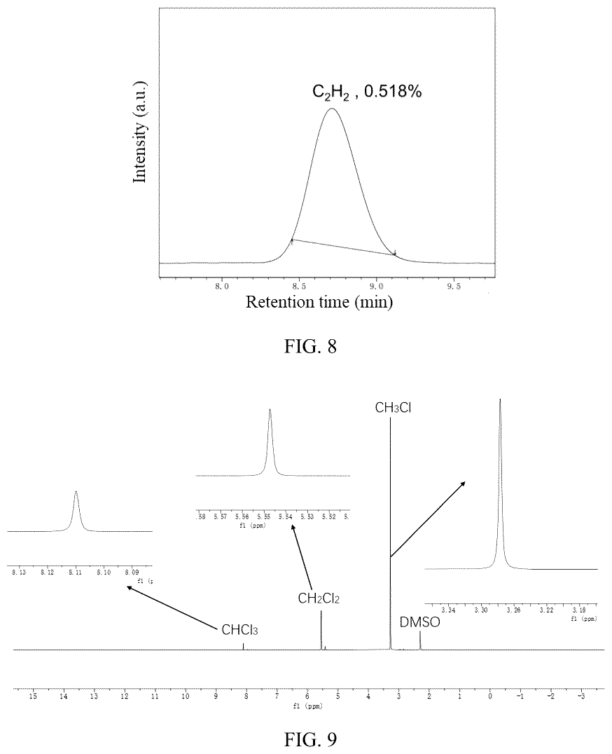

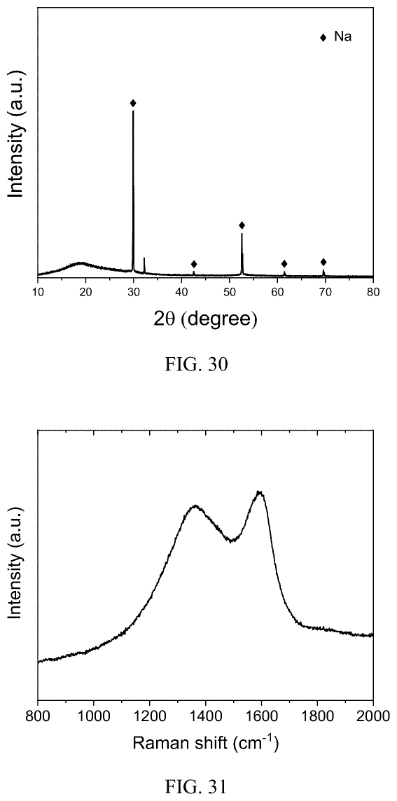

A mixture of methane and nitrogen was introduced to the surface of the anode through the ceramic insulating vent pipe. Methane was used as a hydrocarbon raw material with a flow rate of 3 cm³/min, nitrogen was used as a carrier gas with a flow rate of 17 cm³/min. A voltage of 6V was applied, and gas output from the reactor was collected using deuterated chloroform (CDCl₃) as a solvent. After nuclear magnetic resonance analysis, the results were shown in FIG. 5, distinct signals of monochloromethane and dichloromethane were observed, proving the effective activation of methane at the anode. The composition of the exhaust gas was analyzed using a gas chromatograph (GC). At the fifth hour of electrolysis, the conversion rate of methane reached 60%, and the output rates of hydrogen, ethylene, and acetylene were 3 cm³/min, 0.035 cm³/min, and 0.14 cm³/min, respectively. The GC signals of hydrogen, ethylene, and acetylene were shown in FIGS. 6, 7 and 8, respectively. The above results showed that in the electrochemical system containing LiCl—NaCl—KCl molten salt electrolyte, under the conditions of 500° C. and a voltage of 6V, methane was effectively activated, and the yields of hydrogen, ethylene, and acetylene were high. After the reaction, the reactor was opened. The metal chloride molten electrolyte became a solidified salt at room temperature. Silver-colored block metal was found at the top surface of the solidified salt. Samples of the silver-colored block metal were characterized by XRD, and the results, as shown in FIG. 30, revealed that the major phase of the sample is metallic sodium, indicating that metallic sodium was produced at the cathode during the electrolysis process. In addition, black material was found at the top surface of the solidified salt, and then characterized by Raman spectroscopy. The results, as shown in FIG. 31, revealed the characteristic peaks of graphite at Raman shifts of 1360 cm⁻¹ and 1590 cm⁻¹, indicating that during the reaction, part of the methane was converted into tetrachloromethane, which subsequently formed high-value graphite.

### Embodiment 2

Converting Methane to High-Value Products Using an Electrochemical Device with LiCl—NaCl—KCl Molten Salt Electrolyte

A total of 97.91 g 44% LiCl-25% NaCl-31% KCl (molar fraction) was loaded into an alumina reaction container with an inner diameter of 22 mm and a sealed end. The alumina reaction container was placed in a high-temperature tube furnace. The system was maintained at 300° C. under vacuum for 12 hours to remove the moisture in the salt. At a temperature of 600° C., the salt LiCl—NaCl—KCl melted to form a molten salt with a height of about 15 cm. As shown in FIG. 1, a graphite anode (diameter: 3mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 9 cm into the salt electrolyte. The stainless steel tube cathode is sleeved on the outside of the ceramic insulating vent pipe.

A mixture of methane and argon was introduced to the surface of the anode through the ceramic insulating vent pipe. Methane was used as a hydrocarbon raw material with a flow rate of 3 cm³/min, argon was used as a carrier gas with a flow rate of 17 cm³/min. A constant current of 0.75 A was applied, and the output gas was collected using DMSO as a solvent. After nuclear magnetic resonance analysis, the results were shown in FIG. 9, signals of chloromethane, dichloromethane, and trichloromethane were observed, proving the effective activation of methane at the anode. The composition of the exhaust gas was analyzed using a gas chromatograph. At the 4.5th hour of electrolysis, the conversion rate of methane reached 40%, and the output rates of hydrogen, ethylene, and acetylene were 2.5 cm³/min, 0.05 cm³/min, and 0.07 cm³/min, respectively. The above results showed that in an electrochemical system containing LiCl—NaCl—KCl molten salt electrolyte, methane was effectively activated under the conditions of 600° C. and a constant current of 0.75 A, and the yields of hydrogen, ethylene, and acetylene were high. After the reaction, the reactor was opened and the metal chloride molten electrolyte turned into solidified salt at room temperature. Graphite was found at the top surface of the solidified salt.

### Embodiment 3

A total of 65.27 g 44% LiCl-25% NaCl-31% KCl (molar fraction) was loaded into an alumina reaction container with an inner diameter of 22 mm and a sealed end. The alumina reaction container was placed in a high-temperature tube furnace. The system was maintained at 300° C. under vacuum for 12 hours to remove the moisture in the salt. At the temperature of 500° C., the salt LiCl—NaCl—KCl melted to form a molten salt with a height of about 10 cm. As shown in FIG. 1, a graphite anode (diameter: 3 mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 4 cm into the salt electrolyte. The stainless steel tube cathode was sleeved on the outside of the ceramic insulating vent pipe.

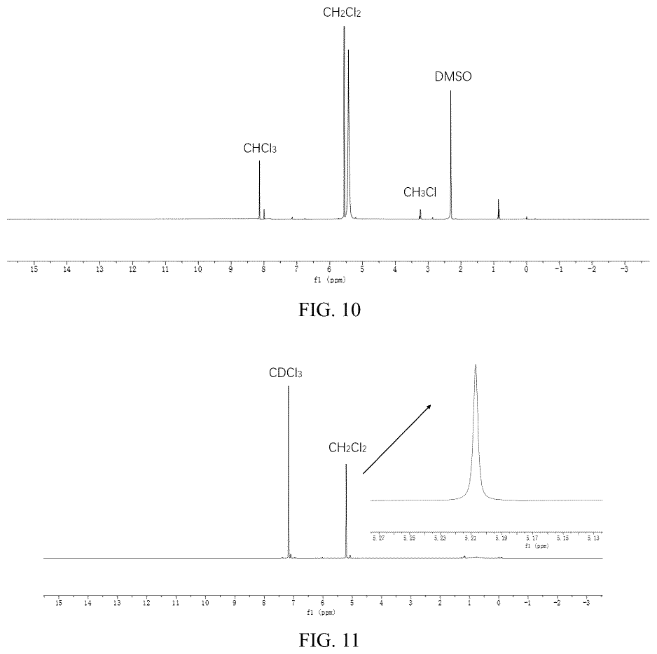

A mixture of methane and argon was introduced to the surface of the anode through the ceramic insulating vent pipe. Methane was used as a hydrocarbon raw material with a flow rate of 3 cm³/min, argon was used as a carrier gas with a flow rate of 17 cm³/min. A constant current of 0.75A was applied, and the output gas was collected using DMSO as a solvent. After nuclear magnetic resonance analysis, the results were shown in FIG. 10, signals of chloromethane, dichloromethane, and trichloromethane were observed, proving the effective activation of methane at the anode. After the reaction, the reactor was opened, and the metal chloride molten electrolyte became a solidified salt at room temperature, and graphite was found at the top surface of the solidified salt.

### Embodiment 4

Converting Methane to High-Value Products Using an Electrochemical Device with LiCl—KCl Molten Salt Electrolyte

A total of 63.43 60% LiCl-40% KCl (molar fraction) was loaded into an alumina reaction container with an inner diameter of 22 mm and a sealed end. The alumina reaction container was placed in a high-temperature tube furnace. At a temperature of 450° C., the LiCl—KCl salt melted to form a molten salt with a height of about 10 cm. As shown in FIG. 1, a graphite anode (diameter: 3mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 4 cm into the salt electrolyte. The stainless steel tube cathode was sleeved on the outside of the ceramic insulating vent pipe.

A mixture of methane and nitrogen was introduced to the surface of the anode through the ceramic insulating vent pipe. Methane was used as a hydrocarbon raw material with a flow rate of 3 cm³ /min, nitrogen was used as a carrier gas with a flow rate of 17 cm³/min. A voltage of 6V was applied, and the output gas was collected using deuterated chloroform as a solvent. After nuclear magnetic resonance analysis, the results were shown in FIG. 11, a signal of dichloromethane was easily observed, proving the effective activation of methane at the anode. The composition of the exhaust gas was analyzed using a gas chromatograph. At the 3rd hour and 40 minutes of electrolysis, the conversion rate of methane reached 50%, the flow rate of the produced hydrogen was about 1 cm³/min, additionally, a small amount of ethylene and acetylene was generated. The above results showed that in an electrochemical system containing LiCl—KCl molten salt electrolyte, methane was effectively activated under the conditions of 450° C. and a voltage of 6V to form hydrogen, ethylene, and acetylene.

### Embodiment 5

A total of 63.43 g 60% LiCl-40% KCl (molar fraction) was loaded into an alumina reaction container with an inner diameter of 22 mm and a sealed end. The alumina reaction container was placed in a high-temperature tube furnace. The system was maintained at 300° C. under vacuum for 12 hours to remove the moisture in the salt. At the temperature of 500° C., the salt LiCl—KCl melted to form a molten salt with a height of about 10 cm. As shown in FIG. 1, a graphite anode (diameter: 3 mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 4 cm into the salt electrolyte. The stainless steel tube cathode was sleeved on the outside of the ceramic insulating vent pipe.

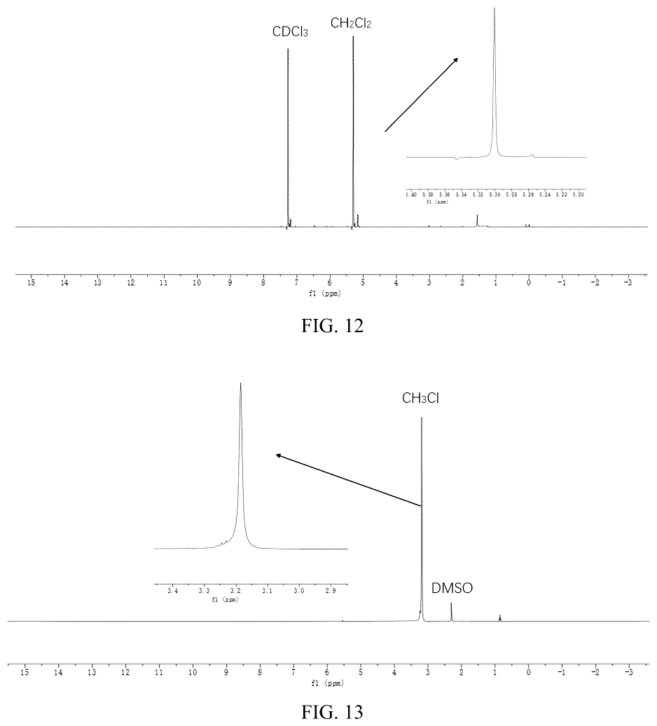

A mixture of methane and nitrogen was introduced to the surface of the anode through the ceramic insulating vent pipe. Methane was used as a hydrocarbon raw material with a flow rate of 3 cm³/min, nitrogen was used as a carrier gas with a flow rate of 17 cm³/min. A voltage of 6V was applied, and the output gas was collected using deuterated chloroform as a solvent. After nuclear magnetic resonance analysis, the results were shown in FIG. 12, a signal of dichloromethane was stronger than that at 450° C., proving methane was effectively activated at the anode, and an increased temperature was conducive to the production of dichloromethane. The composition of the exhaust gas was analyzed using a gas chromatograph. The results showed that the methane conversion rate was approximately 80% and relatively stable, the hydrogen production was approximately 1 ml/min, and the production of ethylene and acetylene increased significantly, with acetylene reaching a maximum flow rate of 0.012 ml/min and ethylene reaching a maximum flow rate of 0.002 ml/min.

### Embodiment 6

Converting Methane to High-Value Products Using an Electrochemical Device with LiCl—KCl—MgCl₂ Molten Salt Electrolyte

A total of 70.18 g of 48% LiCl-32% KCl-20% MgCl₂ (molar fraction) was loaded into an alumina reaction container with an inner diameter of 22 mm and a sealed end. The alumina reaction container was placed in a high-temperature tube furnace. The system was maintained at 300° C. under vacuum for 12 hours to remove the moisture in the salt. At the temperature of 500° C., the salt LiCl—KCl—MgCl₂ melted to form a molten salt with a height of about 10 cm. As shown in FIG. 1, a graphite anode (diameter: 3mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 4 cm into the salt electrolyte. The stainless steel tube cathode was sleeved on the outside of the ceramic insulating vent pipe.

A mixture of methane and argon was introduced to the surface of the anode through the ceramic insulating vent pipe. Methane was used as the hydrocarbon raw material with a flow rate of 3 cm³/min, argon was used as the carrier gas with a flow rate of 17 cm³/min. A constant current of 1 A was applied, and the output gas was collected using DMSO as a solvent. After nuclear magnetic resonance analysis, the results were shown in FIG. 13, a signal of chloromethane was observed, proving the effective activation of methane at the anode.

### Embodiment 7

Converting Methane to High-Value Products Using an Electrochemical Device with LiCl—KCl—MgCl₂ Molten Salt Electrolyte

A total of 70.18 g of 48% LiCl-32% KCl-20% MgCl₂ (molar fraction) was loaded into an alumina reaction container with an inner diameter of 22 mm and a sealed end. The alumina reaction container was placed in a high-temperature tube furnace. The system was maintained at 300° C. under vacuum for 12 hours to remove moisture from the salt. At the temperature of 550° C., the salt LiCl—KCl—MgCl₂ melted to form a molten salt with a height of about 10 cm. As shown in FIG. 1, a graphite anode (diameter: 3 mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 4 cm into the salt electrolyte. The stainless steel tube cathode was sleeved on the outside of the ceramic insulating vent pipe.

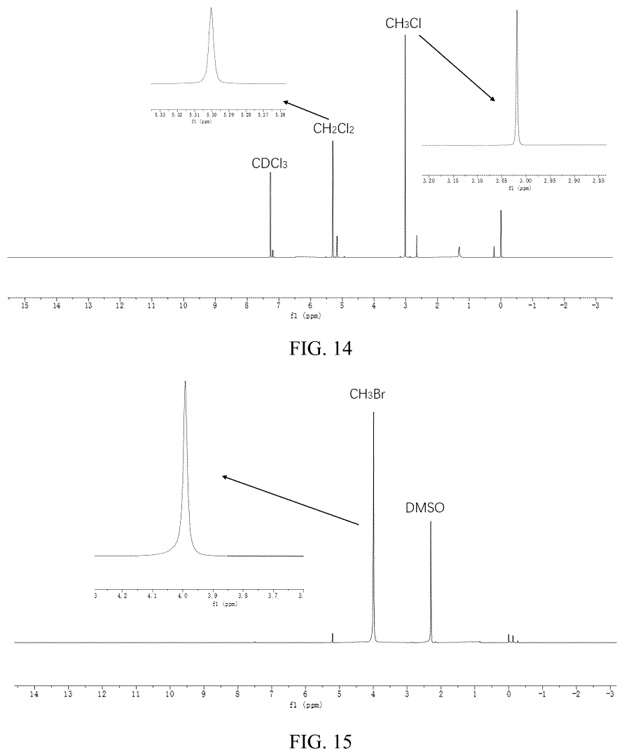

A mixture of methane and argon was introduced to the surface of the anode through the ceramic insulating vent pipe. Methane was used as a hydrocarbon raw material with a flow rate of 3 cm³/min, argon was used as a carrier gas with a flow rate of 17 cm³/min. A constant current of 1 A was applied, and the output gas was collected using deuterated chloroform as a solvent. After nuclear magnetic resonance analysis, the results were shown in FIG. 14, characteristic signals of chloromethane and dichloromethane were observed, indicating that increasing the temperature was conducive to the formation of dichloromethane.

### Embodiment 8

Converting Methane to High-Value Products Using an Electrochemical Device with LiBr—NaBr—KBr Molten Salt Electrolyte

A total of 134.64 g 45% LiBr-25% NaBr-30% KBr (molar fraction) was loaded into an alumina reaction container with an inner diameter of 22 mm and a sealed end. The alumina reaction container was placed in a high-temperature tube furnace. The system was maintained at 300° C. under vacuum for 12 hours to remove moisture from the salt. At the temperature of 500° C., the salt LiBr—NaBr—KBr melted to form a molten salt with a height of about 10 cm. As shown in FIG. 1, a graphite anode (diameter: 3 mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 4 cm into the salt electrolyte. The stainless steel tube cathode was sleeved on the outside of the ceramic insulating vent pipe.

A mixture of methane and argon was introduced to the surface of the anode through the ceramic insulating vent pipe. Methane was used as a hydrocarbon raw material with a flow rate of 3 cm³/min, argon was used as a carrier gas with a flow rate of 17 cm³/min. A constant current of 1 A was applied, DMSO was used as a solvent, and the output gas was collected and analyzed by nuclear magnetic resonance. The results were shown in FIG. 15, the characteristic signal of dibromomethane was observed, proving the effective activation of methane at the anode. The composition of the exhaust gas was analyzed by gas chromatograph. At the 5th hour of electrolysis, the conversion rate of methane reached about 55%, and the production rate of H₂ was 0.32 cm³/min. The above results showed that in the electrochemical system containing LiBr—NaBr—KBr molten salt electrolyte, methane was effectively activated to produce hydrogen under the conditions of 500° C. and a current of 1 A.

### Embodiment 9

Converting Ethane to High-Value Products Using an Electrochemical Device with LiCl—NaCl—KCl Molten Salt Electrolyte

A total of 65.27 g 44% LiCl-25% NaCl-31% KCl (molar fraction) was loaded into an alumina reaction container with an inner diameter of 22 mm and a sealed end. The alumina reaction container was placed in a high-temperature tube furnace. The system was maintained at 300° C. under vacuum for 12 hours to remove the moisture in the salt. At the temperature of 500° C., the salt LiCl—NaCl—KCl melted to form a molten salt with a height of about 10 cm. As shown in FIG. 1, a graphite anode (diameter: 3 mm) was inserted to the bottom of the molten salt electrolyte. A ceramic insulating vent pipe made of alumina was sleeved on the outside of the graphite anode. The graphite anode protruded about 3 cm beyond the ceramic insulating vent pipe. The cathode was a stainless steel tube, which was inserted about 4 cm into the salt electrolyte. The stainless steel tube cathode was sleeved on the outside of the ceramic insulating vent pipe.

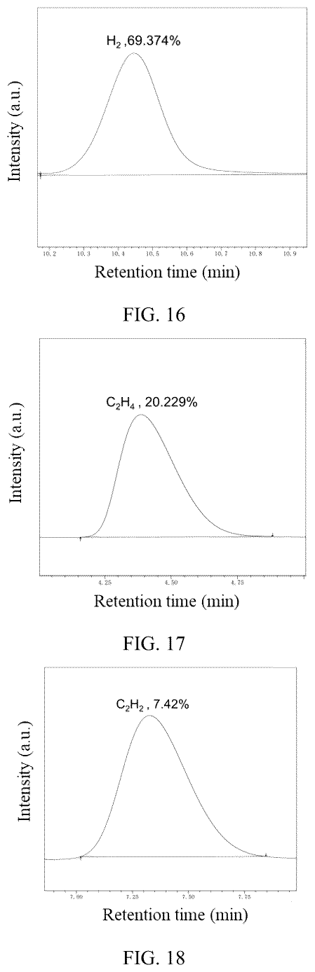

A mixture of ethane and argon was introduced to the surface of the anode through the ceramic insulating vent pipe. Ethane was used as a hydrocarbon raw material with a flow rate of 3 cm³/min, argon was used as a carrier gas with a flow rate of 17 cm³/min. A constant current of 1 A was applied, and the composition of the exhaust gas was analyzed by employing a high-precision gas chromatograph. During the electrolysis process, the conversion rate of ethane was stably kept close to 100%, and the production of hydrogen and ethylene gradually increased with the electrolysis time. At the 8th hour of electrolysis, the hydrogen production rate was about 3 cm³/min, the ethylene production rate was about 1 cm³/min, the selectivity of ethylene reached 25%, and the acetylene production rate was about 0.25 cm³/min. The high-precision GC signals of hydrogen, ethylene, and acetylene in the exhaust gas at the 7.5th hour of electrolysis were shown in FIGS. 16, 17 and 18, respectively. The above results showed that in the electrochemical system containing LiCl—NaCl—KCl molten salt electrolyte, ethane was nearly 100% activated, generating a large amount of hydrogen, ethylene, and acetylene under the conditions of 500° C. and a current of 1 A.

### Embodiment 10

The Reaction of Sodium Metal with Trichloromethane at 400° C. or 500° C.

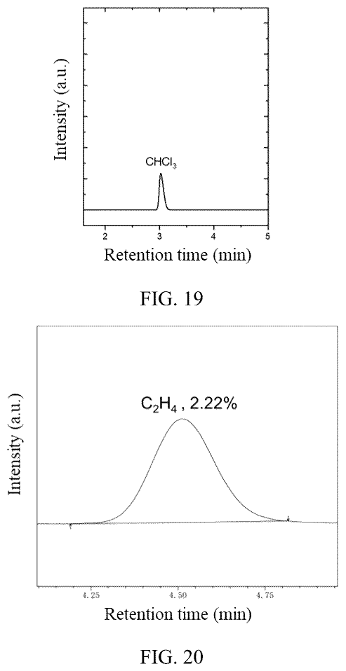

In the experiment, argon (with a flow rate of 17 cm³/min) was introduced through a gas-washing bottle containing liquid trichloromethane with a height of 5 cm, and then the gas was directed into a gas chromatograph specially used for chloroalkane analysis, wherein methane (with a flow rate of 3 cm³/min) was used as the standard gas. The gas chromatography results showed a distinct signal corresponding to trichloromethane, as shown in FIG. 19. This result illustrated that a certain amount of trichloromethane can be carried out from the gas-washing bottle by argon.

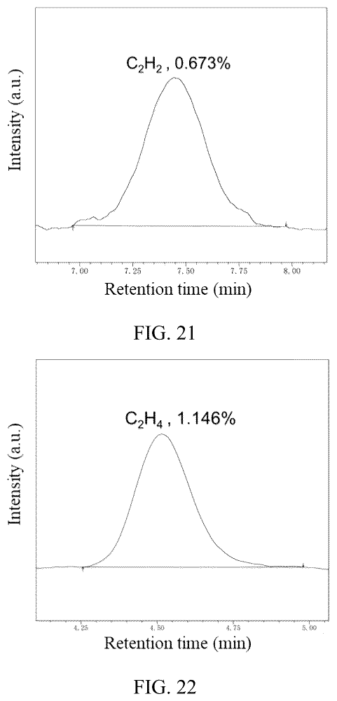

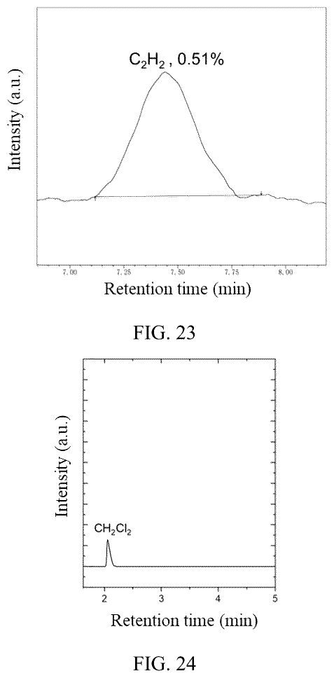

1 g of sodium metal was placed in an alumina porcelain boat, which was then transferred together to a quartz tube with an inner diameter of 42 mm. The system was heated to 400° C. or 500° C. under a flow of argon (with a flow rate of 17 cm³/min). Then argon (with a flow rate maintained at 17 cm³/min) was introduced through the gas-washing bottle containing liquid trichloromethane with a height of 5 cm to carry a certain amount of trichloromethane at room temperature, subsequently, the argon carrying the trichloromethane was directed into the reaction system, so as to react sodium metal with trichloromethane at high temperature. The output gas was introduced into a high-precision gas chromatography to characterize its composition. The results of high-precision gas chromatography showed that the output gas from the reaction of sodium metal and trichloromethane at 400° C. contained ethylene and acetylene, as shown in FIGS. 20 and 21, respectively. The results of high-precision gas chromatography showed that the output gas from the reaction of trichloromethane and sodium metal at 500° C. also contained ethylene and acetylene, as shown in FIGS. 22 and 23, respectively. This embodiment indirectly verified that the sodium metal produced at the cathode can react with the trichloromethane produced at the anode to generate ethylene and acetylene in the electrochemical process. In addition, this embodiment also illustrated that the trichloromethane produced at the anode of the electrochemical system, if not completely reacted, can react with an active metal (such as sodium) to produce unsaturated hydrocarbons.

### Embodiment 11

Reaction of Sodium Metal with Dichloromethane at 400° C. or 500° C.

In the experiment, argon (with a flow rate of 17 cm³/min) was introduced through a gas-washing bottle containing liquid dichloromethane with a height of 5 cm, and then the gas was directed into a gas chromatograph specially used for chloroalkane analysis, wherein methane (with a flow rate of 3 cm³/min) was used as the standard gas. The gas chromatography results showed a distinct signal corresponding to dichloromethane, as shown in FIG. 24. This result illustrated that a certain amount of dichloromethane can be carried out from the gas-washing bottle by argon.

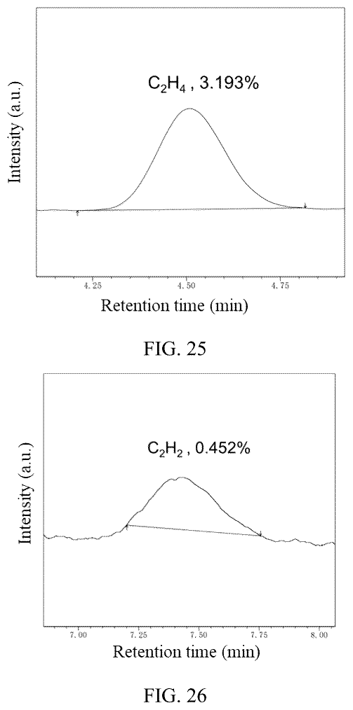

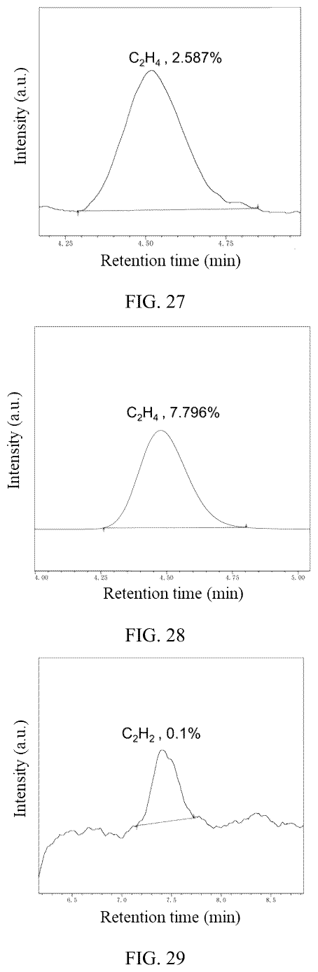

1 g of sodium metal was placed in an alumina porcelain boat, which was transferred together into a quartz tube with an inner diameter of 42 mm. The system was heated to 400° C. or 500° C. under a flow of argon (with a flow rate of 17 cm³ /min). Then argon (with a flow rate maintained at 17 cm³ /min) was introduced through the gas-washing bottle containing liquid dichloromethane with a height of 5 cm to carry a certain amount of dichloromethane at room temperature, subsequently, and the argon carrying the dichloromethane was directed into the reaction system, so as to react dichloromethane with sodium metal at high temperature. The output gas was introduced into a high-precision gas chromatography to characterize its composition. The results of high-precision gas chromatography showed that the output gas from the reaction of sodium metal and dichloromethane at 400° C. contained ethylene and acetylene, as shown in FIGS. 25 and 26, respectively. The results of high-precision gas chromatography showed that the output gas from the reaction of dichloromethane and sodium metal at 500° C. mainly contained ethylene, as shown in FIG. 27. This embodiment indirectly verified that the sodium metal produced at the cathode can react with the dichloromethane produced at the anode to generate ethylene in the electrochemical process. In addition, this embodiment also illustrated that the dichloromethane produced at the anode of the electrochemical system, if not completely reacted, can react with an active metal (such as sodium) to produce unsaturated hydrocarbons.

### Embodiment 12

Reaction of Dichloromethane with Li—Sn Alloy

21.29 g of 60% Li-40% Sn (molar fraction) alloy was added into an alumina reactor with an inner diameter of 13 mm. The system was heated to 500° C. under a flow of argon (with a flow rate of 17 cm³/min), during which the Li—Sn alloy melted with a height of 5 cm. Then, the argon (with a flow rate maintained at 17 cm³/min) was introduced through a gas-washing bottle containing liquid dichloromethane with a height of 10 cm to carry a certain amount of dichloromethane at room temperature, subsequently, the argon carrying the dichloromethane was directed into the reaction system, so as to react dichloromethane with the Li—Sn alloy at high temperature. The output gas was introduced into a high-precision gas chromatography to characterize its composition.

The results of high-precision gas chromatography showed that the output gas from the reaction of liquid Li—Sn alloy and dichloromethane at 500° C. contained ethylene and acetylene, as shown in FIGS. 28 and 29, respectively.

The above embodiments are merely illustrative of the principles and effects of the present disclosure, and are not intended to limit the present disclosure. Anyone skilled in the art may modify or change the above embodiments without violating the spirit and scope of the present disclosure. Therefore, all equivalent modifications or changes made by a person of ordinary skill in the art without departing from the spirit and technical ideas disclosed by the present disclosure shall still be covered by the claims of the present disclosure.

1. A method for converting hydrocarbon raw materials, comprising:
1) reacting a gaseous hydrocarbon raw material with a halogen to produce a haloalkane and a hydrogen halide;
2) reacting the haloalkane provided in step 1) with an active metal to produce a first unsaturated hydrocarbon and a first metal halide; and
3) reacting the hydrogen halide provided in step 1) with an active metal to produce a second metal halide and hydrogen.

2. The method according to claim 1, further comprising one or more of the following:
a1) step 1) is carried out under one or more of electrolysis, light irradiation, and heating;
a2) in step 1), the hydrocarbon raw material is one or more of methane, ethane, propane, and natural gas;
a3) in step 1), the halogen comprises one or more of a halogen ion, a halogen atom, and a halogen molecule;
the halogen atom is one or more of Cl, Br, and I, the halogen ion includes a first halogen ion, the halogen molecule includes a first halogen molecule and/or a second halogen molecule; the first halogen ion is one or more of Cl⁻, Br⁻, and I⁻, the first halogen molecule or second halogen molecule is one or more of Cl₂, Br₂, and I₂;
a4) in step 1), the haloalkane comprises a first haloalkane and/or a second haloalkane; the hydrogen halide comprises a first hydrogen halide and/or a third hydrogen halide;
a5) in step 2) or step 3), the active metal includes a metal element and/or a liquid alloy; the liquid alloy refers to a metal element dissolved in another metal with a low melting point; the metal with a low melting point is one or more of Ga, In, Sn, Pb, Zn, Bi, and Sb; the metal element includes a first metal element; the first metal element is an alkali metal and/or an alkaline earth metal;
a6) in step 3), the hydrogen includes a first hydrogen and/or a third hydrogen.

3. The method according to claim 2, wherein when step 1) is carried out in an electrolysis system, the electrolysis system comprises an anode, a cathode, and a metal halide molten salt;
the metal halide molten salt provides a third metal halide in its molten state, the third metal halide provides a first metal ion and the first halogen ion, and the first metal ion undergoes a reduction reaction at the cathode to provide the first metal element;
the first halogen ion undergoes an oxidation reaction at the anode to provide the first halogen molecule, and the hydrocarbon raw material and the first halogen molecule undergo an oxidation reaction at the anode to provide the first alkyl halide and the first hydrogen halide;
and/or, the first halogen ions react with the hydrocarbon feed gas to produce an oxidation reaction at the anode to provide the first haloalkane and the first hydrogen halide;
at least a portion of the first haloalkane and at least a portion of the first hydrogen halide diffuse to the cathode to undergo a reduction reaction to produce one or more of the first hydrogen, a second halogen ion, the first unsaturated hydrocarbon, and the second metal halide.

4. The method according to claim 3, further comprising one or more of the following:
c1) the metal halide molten salt is a melt of the third metal halide; the third metal halide is one or more of a metal chloride, a metal bromide and a metal iodide; the metal chloride is one or more of LiCl, NaCl, KCl, RbCl, CsCl, MgCl₂, CaCl₂, SrCl₂, BaCl₂, and ZnCl₂; the metal bromide is one or more of LiBr, NaBr, KBr, RbBr, CsBr, MgBr₂, CaBr₂, SrBr₂, BaBr₂, and ZnBr₂; the metal iodide is one or more of LiI, NaI, KI, RbI, CsI, MgI₂, CaI₂, SrI₂, BaI₂, and ZnI₂;
c2) for per unit volume (1 cm³) of the metal halide molten salt, a flow rate of the hydrocarbon raw material is in a range of 0.02 to 0.8 cm³/min; and
c3) a reaction temperature of the electrolyte system is in a range of 200-600°C.; a reaction voltage of the electrolyte system is in a range of 3-10V.

5. The method according to claim 3, wherein the reduction reaction comprises one or more of the following:
d1) the third metal halide accepts electrons to provide the first metal element and the second halogen ion; the first metal element reacts with the first haloalkane to produce the first unsaturated hydrocarbon and the first metal halide;
d2) the third metal halide accepts electrons to provide the first metal element and the second halogen ion; the first metal element reacts with the first hydrogen halide to produce the first hydrogen and the second metal halide; and
d3) the first hydrogen halide accepts electrons to produce a second hydrogen and a third halogen ion.

6. The method according to claim 3, wherein in d1), when the first haloalkane is CCl₄, it reacts with the first metal element to produce graphite and the first metal halide;
and/or, in d1), when the first haloalkane is CCl₄, it decomposes into graphite and chlorine.

7. The method according to claim 3, further comprising a step for post treatment of a remaining part of the first haloalkane and a remaining part of the first hydrogen halide, wherein the post treatment comprises one or more of the following:
e1) reacting the remaining part of the first haloalkane with a basic substance to produce an alcohol, an aldehyde, a carboxylic acid, and a fourth metal halide; the basic substance comprises one or more of a basic aqueous solution, a basic solid and a basic melt; the basic aqueous solution is one or more of a lithium hydroxide aqueous solution, a sodium hydroxide aqueous solution and a potassium hydroxide solution aqueous; the basic solid is one or more of lithium hydroxide, sodium hydroxide and potassium hydroxide; the basic melt is one or more of molten lithium hydroxide, molten sodium hydroxide and molten potassium hydroxide;
e2) reacting the remaining part of the first haloalkane in the presence of a catalyst to produce a second unsaturated hydrocarbon and a second hydrogen halide; the catalyst is a zeolite catalyst;
e3) reacting the remaining part of the first haloalkane with the active metal to produce a third unsaturated hydrocarbon and a fifth metal halide;
e4) recovering the remaining part of the first haloalkane and reintroducing it for reaction to produce the first unsaturated hydrocarbon and the first metal halide; and
e5) reacting the remaining part of the first hydrogen halide with the active metal to produce a sixth metal halide and the third hydrogen.

8. The method according to claim 2, wherein when step 1) is carried out under light irradiation and/or heating:
a wavelength of light is in a range of 200 to 450 nm, a reaction temperature is in a range of 20 to 600° C, a heating temperature is no less than 250° C;
under the light irradiation and/or heating condition, the hydrocarbon raw material reacts with the second halogen molecule to provide the second haloalkane and the third hydrogen halide, the second haloalkane reacts with the active metal to provide a third unsaturated hydrocarbon and a fifth metal halide, and the third hydrogen halide reacts with the active metal to provide a sixth metal halide and the third hydrogen;
a step for post treatment is also included, wherein the post treatment comprises: electrolyzing the fifth metal halide and/or the sixth metal halide to provide a second metal element and the second halogen molecule, recycling the second metal element for use in step 2) or step 3), and recycling the second halogen molecule for use in step 1).

9. An electrochemical device, comprising a reaction container (1), wherein the reaction container (1) comprises a metal halide molten salt unit (4); the metal halide molten salt unit (4) is provided with an anode (3) and a cathode (2);
wherein the electrochemical device further comprises a vent pipe (5) for supplying gas to the anode (3), and the vent pipe (5) is communicated with the metal halide molten salt unit (4).

10. The electrochemical device according to claim 9, further comprising one or more of the following:
f1) the vent pipe (5) is provided with a gas inlet port (6);
f2) an independent chamber (7); wherein the independent chamber (7) is communicated with the reaction container (1) and is not in communication with the metal halide molten salt unit (4);
f3) the vent pipe (5) is sleeved on the anode (3); the cathode (2) is sleeved on the vent pipe (5);
f4) the cathode (2) is independently arranged in the metal halide molten salt

(4);
f5) the anode (3) is closer to the bottom of the reaction container (1) than the vent pipe (5);
f6) the anode (3) is made of graphite;
f7) the cathode (2) is made of one of stainless steel, nickel, titanium, and nickel-based alloy;
f8) the reaction container (1) is made of alumina; and
f9) the vent pipe (5) is a ceramic insulating vent pipe.

11. Use of the method for converting hydrocarbon raw materials according to claim 1 in the preparation of an unsaturated hydrocarbon.

12. The method according to claim 2, wherein the hydrocarbon raw material gas is methane and/or ethane; and
wherein the first metal element is one or more of Li, Na, K, Rb, Cs, Mg, Ca, Sr, and Ba.

13. The method according to claim 12, wherein the hydrocarbon raw material gas is ethane.

14. Use the electrochemical device according to claim 9 in the preparation of an unsaturated hydrocarbon.
